(19) United States
(12) Patent Application Publication
(10) Pub. No.: US 2006/0239740 A1
(43) Pub. Date: Oct. 26, 2006

(54) Image forming apparatus adopting thermal printing head

(75) Inventors: Dong-Su Nam, Suwon-si (KR); Ju-Hyun Park, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/325,421

(22) Filed: Jan. 5, 2006

(30) Foreign Application Priority Data
Apr. 20, 2005 (KR) 2005-32768

(51) Int. Cl. B41J 2/32; B41J 3/60; B41J 15/04; B41J 13/10

(52) U.S. Cl. 400/120.01; 400/149; 400/595; 400/642; 400/188

(57) ABSTRACT

An image forming apparatus is provided which employs a thermal print head. The image forming apparatus includes the thermal print head, a platen roller forming a printing nip while facing the thermal print head, an aperture formed on an upstream side of the printing nip with respect to a direction in which a medium is transferred, and a support member arranged between the aperture and the printing nip. The support member supports the medium on a side opposite to the side where the thermal print head is located.

### CROSS-REFERENCE TO RELATED APPLICATIONS

This application claims the benefit under 35 U.S.C. § 119(a) of Korean Patent Application No. 10-2005-0032768, filed on Apr. 20, 2005, the entire disclosure of which is hereby incorporated by reference.

### BACKGROUND OF THE INVENTION

1. Field of the Invention

The present invention relates to an image forming apparatus. More particularly, the present invention relates to an image forming apparatus employing a thermal printing head (TPH).

2. Description of the Related Art

Referring to FIG. 1, a conventional image forming apparatus includes a thermal printing head (TPH) 1 and a platen roller 2 which comes into contact with the TPH 1 to form a printing nip (N). An aperture 6 is formed in a housing 5 which forms an exterior of the conventional image forming apparatus. A medium 10 is supplied to the printing nip N via the aperture 6. For example, to perform printing, a user supplies the medium 10 to the printing nip N via the aperture 6. When the platen roller 2 rotates, the medium 10 is transferred in direction X1 (which is indicated by an arrow). The TPH 1 prints an image by applying heat to the medium 10. In an initial stage of printing, the medium 10 is curved slightly as indicated by reference numeral 10a. Thereafter, when printing progresses to some degree, the medium 10 straightens out by its rigidity as indicated by reference numeral 10b. To obtain a printed image of good quality, a state in which the medium 10 approaches the printing nip N should be uniform. In other words, an angle at which the medium 10 approaches the printing nip N should be constant during printing. However, the angle 4a of the medium 10 approaching the printing nip N changes to an angle 4b when the printing progresses to some degree and the medium 10 straightens as indicated by 10b. This causes a thermal energy difference between the TPH 1 and the medium 10. Consequently, the printing of non-uniform images may result. Moreover, the medium 10 may vibrate in a direction Y while being straightened from state 10a to the state 10b. In this case, tension that is applied to the medium 10 may change. Therefore, parallel stripes may form along a width of the medium 10 and on the printed image.

Accordingly, there is a need for an improved image forming apparatus employing a thermal printing head (TPH) which reduces thermal energy differences, limits vibrations, and reduces changes in tension applied to the medium to improve the quality of a printed image.

### SUMMARY OF THE INVENTION

An aspect of the embodiments of the present invention is to address at least the above problems and/or disadvantages and to provide at least the advantages described below. Accordingly, an aspect of the present invention is to provide a thermal type image forming apparatus which arranges a medium at a uniform angle with respect to a printing nip formed by a TPH and a platen roller.

Accordingly, another aspect of the present invention is to provide an improved thermal type image forming apparatus capable of printing a good quality image without being affected by vibrations caused by the rigidity of the medium.

According to an aspect of the present invention, there is provided a thermal type image forming apparatus including a thermal print head, a platen roller which forms a printing nip while facing the thermal print head, an aperture formed on an upstream side of the printing nip with respect to a direction in which a medium is transferred, and a support member which is placed between the aperture and the printing nip. The support member supports the medium on a side opposite to the side where the thermal print head is located.

The thermal type image forming apparatus may further include a guide unit positioned between the aperture and the support member. The guide unit is shaped to support the medium on a side opposite to the side where the support member is installed.

The image forming apparatus may include two thermal print heads that face each other while having the platen roller arranged between the thermal print heads. The support member supports the medium at a position between each of two printing nips formed by the two thermal print heads in cooperation with the platen roller and the aperture. The guide unit comprises a first guide unit and a second guide unit facing each other while having the support member between the first and second guide units.

The thermal print head may rotate about the platen roller to move to the first position facing the first surface of the medium and to the second position facing the second surface of the medium that is opposite to the first surface. The support member supports the medium at a position between each of two printing nips formed by the thermal print head at the first and second positions and the aperture. The guide unit comprises a first guide unit and a second guide unit facing each other while having the support member between the first and second guide units.

According to another aspect of the embodiments of the present invention, there is provided an image forming apparatus including a thermal print head, a platen roller forming a printing nip while facing the thermal print head, a transfer unit which transferrs a medium in a first direction to supply the medium to the printing nip and in a second direction opposite to the first direction, and an aperture formed on the first direction side of the printing nip with respect to the first direction through which the medium being transferred in the first direction is discharged. A support member is placed between the aperture and the printing nip to support the medium on a side opposite to the side where the thermal print head is located.

The image forming apparatus may further include a guide unit positioned between the aperture and the support member. The guide unit is shaped to support the medium on a side opposite to the side where the support member is installed.

The thermal print head may rotate about the platen roller to move to the first position facing the first surface of the medium and to the second position facing the second surface of the medium that is opposite to the first surface. The support member supports the medium at a position between each of two printing nips formed by the thermal print head at the first and second positions and the aperture. The guide unit includes a first guide unit and a second guide unit facing each other while having the support member between the first and second guide units.

Other objects, advantages, and salient features of the invention will become apparent to those skilled in the art from the following detailed description, which, taken in conjunction with the annexed drawings, discloses preferred embodiments of the invention.

### BRIEF DESCRIPTION OF THE DRAWINGS

The above and other objects, features, and advantages of certain embodiments of the present invention will be more apparent from the following description taken in conjunction with the accompanying drawings, in which:

FIG. 1 illustrates a schematic structure of a conventional image forming apparatus;

FIG. 2 illustrates a schematic structure of an image forming apparatus according to an exemplary embodiment of the present invention;

FIG. 3 illustrates a schematic structure of an image forming apparatus according to another exemplary embodiment of the present invention;

FIGS. 4 and 5 illustrate a schematic structure of an image forming apparatus according to another exemplary embodiment of the present invention;

FIGS. 6 and 7 are a perspective view and an exploded perspective view, respectively, of a structure which moves a thermal printing head (TPH) to first and second positions in the image forming apparatus as shown in FIGS. 4 and 5;

FIG. 8 is an exploded perspective view of a bushing shown in FIG. 7.

FIG. 9 is an exemplary cross-section of a medium used in the image forming apparatuses according to the embodiments as shown in FIGS. 2 through 5;

FIGS. 10A through 10I illustrate a method of moving the TPH to the first and second positions.

Throughout the drawings, the same drawing reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of the exemplary embodiments of the invention. Accordingly, those of ordinary skill in the art will recognize that various changes and modifications of the exemplary embodiments described herein can be made without departing from the scope and spirit of the invention. Also, descriptions of well-known functions and constructions are omitted for clarity and conciseness.

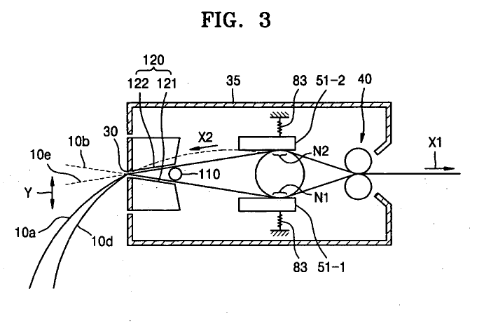

FIG. 2 illustrates a schematic structure of an image forming apparatus according to an exemplary embodiment of the present invention. Referring to FIG. 2, the image forming apparatus includes a thermal printing head (TPH) 51 and a platen roller 52. An elastic member 83 pushes the TPH 51 toward the platen roller 52. When the platen roller 52 comes into contact with the TPH 51, the platen roller 52 slightly transforms to form a printing nip (N). An aperture 30 is formed on a housing 35. The aperture 30 is placed on an upstream side of the printing nip N with respect to a direction in which a medium 10 is transferred. The medium 10 is supplied to the printing nip N via the aperture 30. The medium 10 is transferred in direction X1 by the platen roller 52 and a transfer unit 40. A support member 110 is installed between the aperture 30 and the printing nip N. The support member 110 is located on the side opposite to the side where the TPH 51 is located to contact the medium 10. Although the support member 110 of FIG. 2 has a cylindrical shape, the shape of the support member 110 is not limited thereto, and other suitable arrangements and constructions maybe used.

Referring to FIG. 2, in an initial stage of printing, the medium 10 is curved as indicated by reference numeral 10a. Thereafter, when the printing progresses to some degree, a relatively short length of a portion of the medium 10 remains outside the aperture 30. The medium 10 is straightened by its rigidity as indicated by reference numeral 10b. If no support members 110 are included, the medium 10 is curved as indicated by reference numeral 10c as it approaches the printing nip N. However, in this exemplary embodiment, because the support member 110 supports the medium 10, the medium 10 is not curved or is very slightly curved when approaching the printing nip N. Hence, although a curving state of the portion of the medium 10 remaining outside the aperture 30 changes, an incidence angle 4 of the medium 10 with respect to the printing nip N is maintained nearly constant. Thus, a sufficient amount of thermal energy of the TPH 51 is uniformly transmitted to the medium 10, thereby obtaining a printed image of good quality.

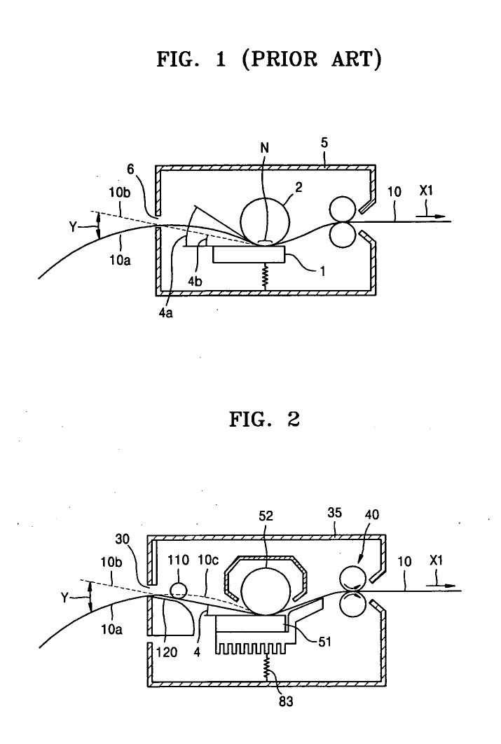

In addition, at the moment when the medium 10 in the state 10a is straightened into the state 10b, the medium 10 vibrates in direction Y. For example, in a manner similar to a diving board vibrating after a diver dives. In the conventional image forming apparatus of FIG. 1, the printing nip N is at fixed end of the vibrating medium 10, and the portion of the medium 10 remaining outside the aperture 6 is the free end. Accordingly, the vibration of the medium 10 is transferred to the printing nip N without change, thereby degrading the quality of printing. However, in this exemplary embodiment, the support member 110 serves as a fixed end of the medium 10, so that a portion of the medium 10 between the support member 110 and the printing nip N is not curved. Hence, the vibration of the medium 10 can be greatly minimized if transferred to the printing nip N. Therefore, generation of horizontally long stripes on the printed image can be prevented.

In another aspect of the present exemplary embodiment, a guide unit 120 may be further installed between the aperture 30 and the support member 110. The guide unit 120 is shaped, for example linearly, to support the medium 10 and extends in a direction where the medium 10 is transferred. The guide unit 120 supports the medium 10 on the side opposite to the side where the support member 110 is arranged. The guide unit 120 keeps the medium 10 straight without being curved between the aperture 30 and the support member 110. The support member 110 and the guide unit 120 contribute to more effectively maintaining the incidence angle 4 of the medium 10 with respect to the printing nip N. Moreover, the support member 110 and the guide unit 120 prevent transmission of the vibration of the medium 10 to the printing nip N.

Referring to FIG. 3, an image forming apparatus according to another exemplary embodiment of the present invention includes two TPHs 51-1 and 51-2. The two TPHs 51-1 and 51-2 have a platen roller 52 therebetween, face each other, and form printing nips N1 and N2, so that both surfaces of the medium 10 can be printed with images. For example, the medium 10 received through the aperture 30 passes the printing nip N while moving in direction X1. At this time, the TPH 51-1 prints an image by heating one surface of the medium 10. The medium 10 is transferred in direction X2 and enters the printing nip N2 formed between the TPH 51-2 and the platen roller 52. A portion of the medium 10 comes out through the aperture 30 as indicated by reference numeral 10d. The medium 10 is transferred back in direction X1 to print an image on the other surface of the medium 10. As a length of the medium 10 remaining outside the aperture 30 becomes shorter, the medium 10 vibrates while changing from a state indicated by 10d to a state indicated by reference numeral 10e. The support member 110 keeps an incidence angle of the medium 10 with respect to the printing nip N2 constant by supporting the medium 10 on the side opposite to the side where the TPH 51-2 is installed. Moreover, to support the medium 10 together with the support member 110, first and second guide units 121 and 122 having straight line shapes face each other while having the support member 110 therebetween. The first and second guide units 121 and 122 comprise the guide unit 120 of FIG. 2. In particular, the second guide unit 122 prevents the medium 10 from being curved between the aperture 30 and the support member 110.

The medium 10 may have a structure as illustrated in FIG. 9. Referring to FIG. 9, ink layers 12 and 13 with predetermined colors are formed on both surfaces of a base sheet 11, which are first and second surfaces, respectively. The ink layers 12 and 13 may include a single layer for representing a single color, or multiple layers for representing a plurality of colors. For example, the ink layer 12 on the first surface of the base sheet 11 may be formed of two layers to express the colors yellow (Y) and magenta (M), and the ink layer 13 on the second surface thereof may be formed of a single layer to express the color cyan (C). The ink layers 12 and 13 may represent identical colors.

If the base sheet 11 is transparent, an opaque film may be formed on one of the ink layers 12 and 13, for example, the ink layer 12. The TPH 51 is located at a first position and prints images with Y and M colors by heating the ink layer 12. The TPH 51 is located at a second position and prints an image with a C color by heating the ink layer 13. A complete color image in which the Y, M, and C color images overlap can be recognized when the image is viewed from the side of the base sheet 11 on which the ink layer 13 is formed. The thermal type image forming apparatuses according to the exemplary embodiments of the present invention illustrated in FIGS. 2 and 3 may be used to perform double-sided printing. On the other hand, if the base sheet 11 is opaque, double-sided printing is possible by printing different images on the first and second surfaces of the medium 10.

The exemplary embodiments illustrated in FIGS. 2 and 3 may be applied to thermal image forming apparatuses that print images by heating an ink ribbon having a thermal ink layer using a TPH and transferring ink onto paper.

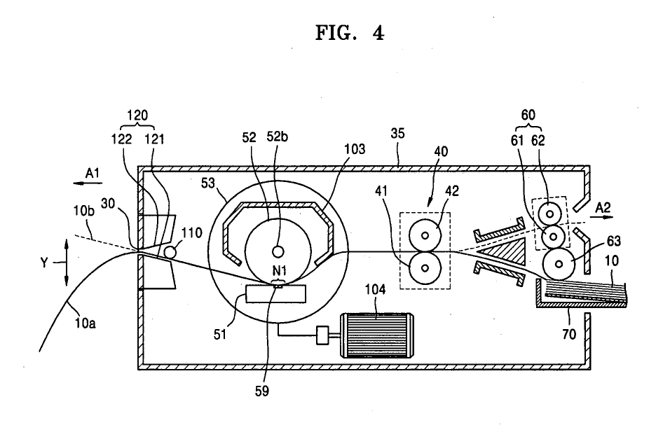

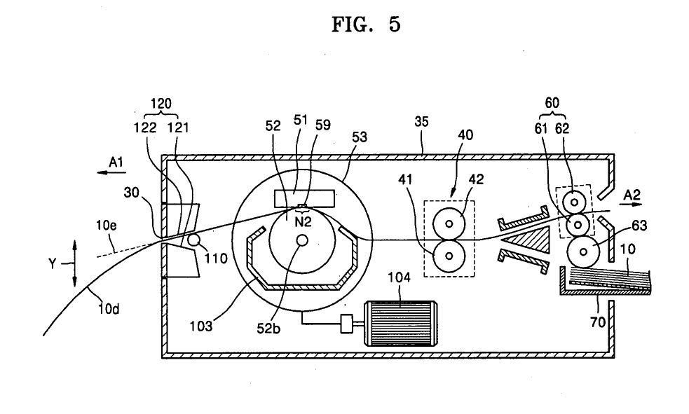

FIGS. 4 and 5 illustrate a schematic structure of a thermal image forming apparatus according to another exemplary embodiment of the present invention. As illustrated in FIGS. 4 and 5, a TPH 51 rotates about a platen roller 52 to move to either a first position (illustrated in FIG. 4) or a second position (illustrated in FIG. 5), which face first and second surfaces, respectively, of the medium 10. The TPH 51 at the first position and the platen roller 52 form the printing nip N1. The TPH 51 at the second position and the platen roller 52 form the printing nip N2. The TPH 51 is coupled to support brackets 53. When the support bracket 53 is rotated by a motor 104, the TPH 40 rotates about the platen roller 52 and moves to either the first or second position. A transfer unit 40 transfers the medium 10.

An aperture 30 is formed on housing 35. The medium 10 is picked up from a cassette 70 by a pickup roller 63 and is transferred in a first direction A1 by the transfer roller 40 to reach the printing nip N1. A portion of the medium 10 comes out of the housing 35 via the aperture 30. When the medium 10 is located at a print start position, the transfer roller 40 transfers the medium 10 in a second direction A2. The TPH 51 heats the first surface of the medium 10 to print an image on the first surface of the medium 10. A discharge unit 60 temporarily discharges the medium 10 on which the first surface has been printed with an image. When the medium 10 escapes from the printing nip N1, the transfer unit 40 stops transferring the medium 10. A motor 104 moves the TPH 51 to the second position by rotating the support brackets 53. The transfer roller 40 transfers the medium 10 back in the first direction A1 so that the medium 10 can reach the printing nip N1. The second surface of the medium 10 faces the TPH 51. A portion of the medium 10 is discharged again from the housing 35 via the aperture 30. When the medium 10 is located at the print start position, the transfer roller 40 transfers the medium 10 in the second direction A2. The TPH 51 prints an image on the second surface of the medium 10 by heating the second surface. The discharge unit 60 discharges the medium 10 on which both surfaces have been printed with images.

A support member 110 supports the medium 10 between the aperture 30 and the two printing nips N1 and N2 formed when the TPH 51 is located at the first and second positions. First and second guide units 121 and 122 face each other while having the support member 10 therebetween. Operations of the support member 110 and the first and second guide units 121 and 122 are the same as those described above with reference to FIGS. 2 and 3.

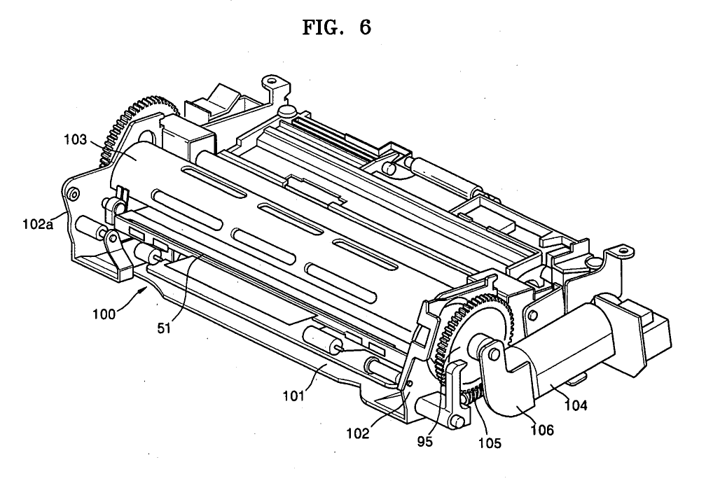

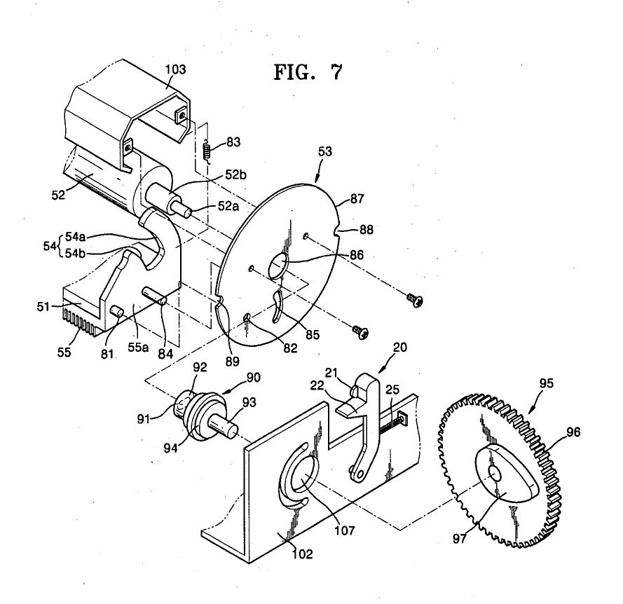

FIGS. 6 and 7 are a perspective view and an exploded perspective view, respectively, of a structure for moving the TPH 51 to the first and second positions. Referring to FIGS. 6 and 7, a frame 100 includes a bottom base 101, and two lateral plates 102 and 102a which extend up from both lateral sides of the bottom base 101. The cassette 70, in which the medium 10 is contained, is arranged on a side of the frame 100. Referring to FIGS. 4 and 5, the pickup roller 63 for picking up the medium 10 from the cassette 70 is arranged over the cassette 70 on the frame 100. The discharge unit 60, which includes a discharge roller 61 and an idle roller 62 engaging with the discharge roller 61, is arranged on the pickup roller 63 to discharge a medium 10 on which an image has been printed. In the present exemplary embodiment, the discharge roller 61 and the pickup roller 63 contact each other and are driven by a single driving motor (not shown). The driving motor may be connected with the lateral plate 102a. The TPH 51 and the platen roller 52 are arranged opposite to the discharge unit 60 between the two lateral plates 102 and 102a. The medium 10 is transferred by the transfer unit 40. The transfer unit 40 includes a pair of rollers 41 and 42 which elastically engage with each other. A rotating force of the driving motor is transmitted to only one of the rollers 41 and 42, and the other roller is driven by the driven roller.

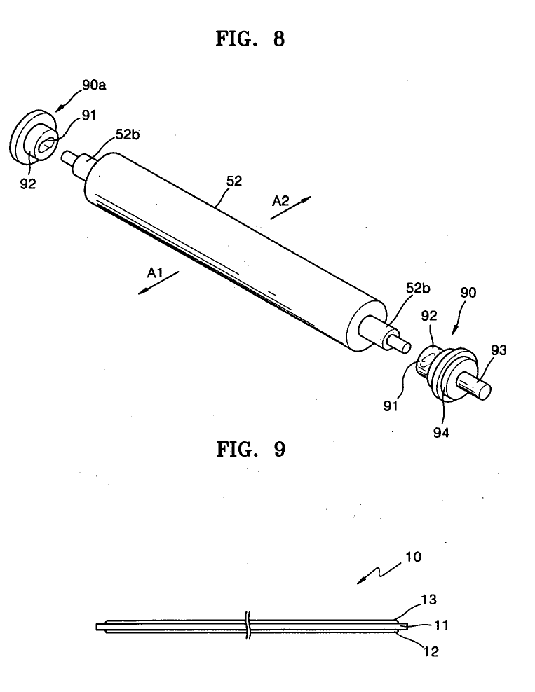

Referring to FIGS. 7 and 8, bushings 90 and 90a are coupled to the two lateral plates 102 and 102a, respectively. Each of the bushings 90 and 90a includes an inner circumferential portion 91 and a first outer circumferential portion 92. Both ends of the platen roller 52 are inserted into the inner circumferential portions 91 of the bushings 90 and 90a. A pair of support brackets 53 are rotatably coupled to the first outer circumferential portions 92 of the bushings 90 and 90a (only one of the support brackets 53 is shown in FIG. 7).

A heat sink 55 for discharging heat from the TPH 51 is coupled to the TPH 51. Hinge shafts 81 formed on both lateral portions 55a of the heat sink 55 are inserted into hinge holes 82 formed in the pair of support brackets 53 (only one of the support brackets 53 is shown in FIG. 7). The TPH 51 is coupled to the support brackets 53 so as to rotate about the hinge holes 82. A rotation guide 103 is coupled to the support brackets 53. The rotation guide 103 guides a medium 10 transferred by the transfer unit 40 to a location between the TPH 51 and the platen roller 52. The TPH 51 is elastically biased by an elastic member 83 in such a direction to contact the platen roller 52. For example, as shown in FIG. 7, the elastic member 83 may be a tensile coil spring having one end connected to the TPH 51, and the other end connected to the rotation guide 103, which covers the platen roller 52.

One end of a shaft 84 is formed on a lateral portion 55a of the heat sink 55, and the other end thereof is inserted into a through hole 85 formed in the support bracket 53. The through hole 85 is preferably arcuately shaped around the hinge hole 82 to allow the TPH 51 to contact/separate from the platen roller 52. In the exemplary embodiment, the platen roller 52 is not connected to a driving motor (not shown). However, the platen roller 52, which is in contact with the medium 10 that is transferred by the transfer unit 40, is rotated by the medium 10.

The bushing 90 further includes a second outer circumferential portion 93 which is concentric with the first outer circumferential portion 92. A rotating cam 95 is rotatably combined with the second outer circumferential portion 93. The rotating cam 95 includes a gear portion 96 and a cam portion 97 which contacts the shaft 84. Referring to FIG. 6, the motor 104 has a worm gear 105 which engages with the gear portion 96. A bracket 106, to which the motor 104 is coupled, is integrally connected with the lateral plate 102. Referring back to FIG. 7, the bushing 90 further includes a third outer circumferential portion 94, which is inserted into a hole 107 formed in the lateral plate 102, and the end of the second outer circumferential portion 93 is supported by the bracket 106. The bracket 106 prevents the rotating cams 95 from being detached from the second outer circumferential portions 93 at the two lateral plates 102 and 102a. The bushing 90a of FIG. 8 includes the inner circumferential portion 91 and the first and third outer circumferential portions 92 and 94. According to this structure, the support brackets 53 and the rotating cam 95 are rotated about the same rotating axis, and the TPH 51 is also rotated about the same rotating axis. The support bracket 53 has a circular circumference 87. First and second engagement grooves 88 and 89 are formed and separated from each other by 180 degrees along the circumference 87. A locking member 20 is rotatably combined with the lateral plate 102. A first elastic member 25 applies an elastic force to the locking member 20 in a direction so that the locking member 20 can engage with the first or second engagement groove 88 or 89. The locking member 20 releases from the first and second engagement grooves 88 and 89 by the rotating cam 95, and engages with the first or second engagement grooves 88 or 89 by the elastic force of the elastic member 25. The locking member 20 includes a protrusion 21, which is inserted into the first or second engagement grooves 88 or 89, and an interfering portion 22, which interferes with the cam portion 97 of the rotating cam 95.

Referring to FIGS. 4 and 5, heating lines 59 should be aligned with the printing nips N1 and N2, which are formed by the platen roller 52 to effectively heat the medium 10. To align the heating lines 59 and the printing nips N1 and N2, the image forming apparatus includes a control member 54 of FIG. 7. Referring to FIG. 7, the control member 54 includes a first control portion 54a, which contacts an end portion 52b of the platen roller 52 when the TPH 51 is located at the first position, and a second control portion 54b, which contacts the end portion 52b of the platen roller 52 when the TPH 51 is located at the second position. While the medium 10 is being transferred in the second direction A2, the platen roller 52 tends to be pulled in the second direction A2. The first and second control portions 54a and 54b control a motion of the platen roller 52 in the second direction A2. The first and second control portions 54a and 54b are formed in both lateral portions 55a of the heat sink 55. Moreover, the first and second control portions 54a and 54b are preferably arcuately shaped around the hinge hole 82. As shown in FIG. 8, both ends of the platen roller 52 are inserted into the inner circumferential portions 91 of the bushings 90 and 90a and rotatably supported by the bushings 90 and 90a. The inner circumferential portions 91 of the bushings 90 and 90a are preferably elongate in the first and second directions A1 and A2. The control member 54 controls the platen roller 52 so as to not move excessively in the second direction A2 along the inner circumferential portions 91 of the bushings 90 and 90a. Thus, the heating lines 59 of the TPH 51 are aligned with the printing nips N1 and N2. Due to this alignment, thermal energy provided by each of the heating lines 59 is stably transmitted to the medium 10 to thus achieve stable, high-quality printing.

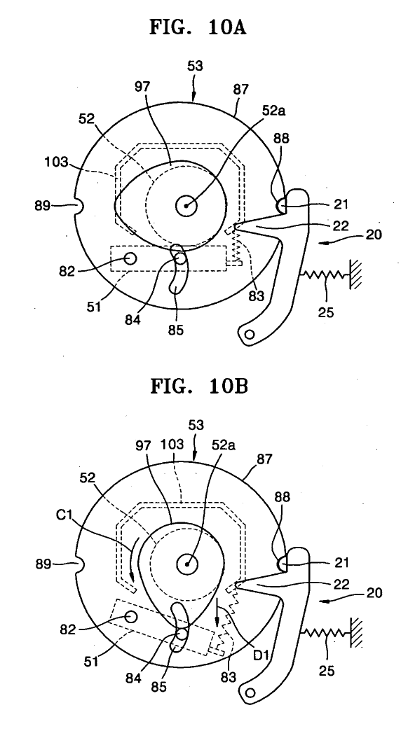

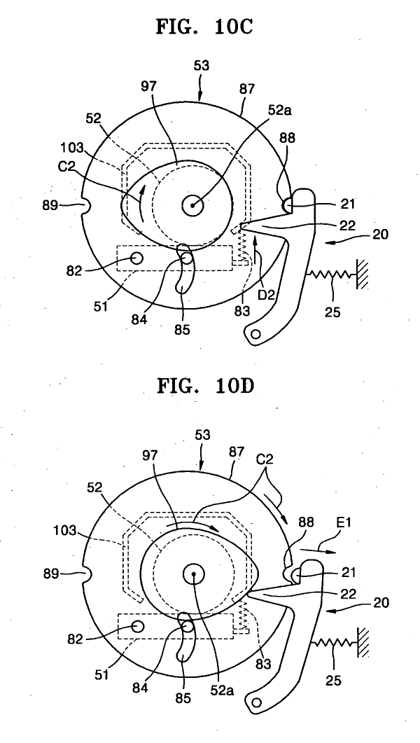

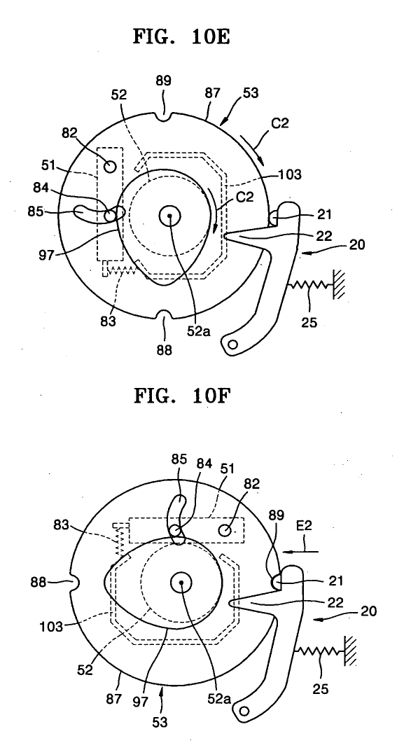

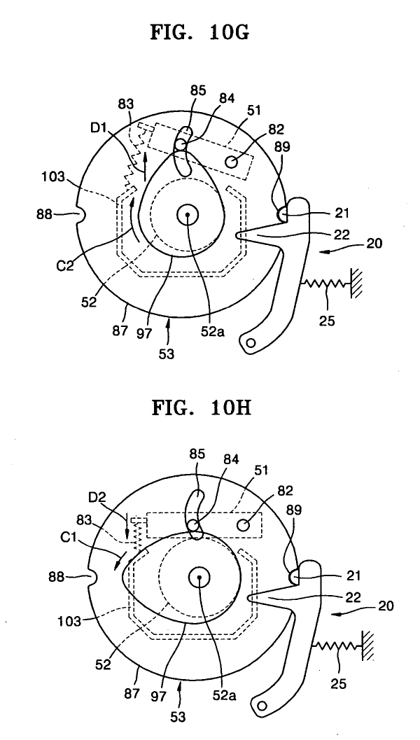

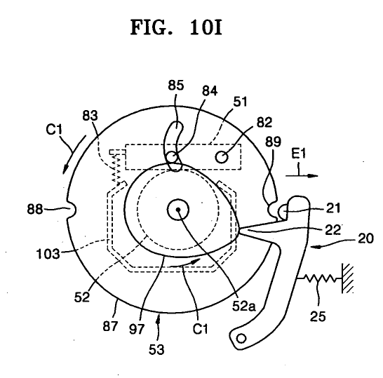

FIGS. 10A through 10I illustrate a movement of the TPH 51 to the first and second positions. As shown in FIG. 10A, the TPH 51 contacts the platen roller 52. The protrusion 21 of the locking member 20 engages with the first engagement groove 88, so that the TPH 51 is locked at the first position. The medium 10, which is withdrawn from the cassette 70 by the pickup roller 63, is transferred in the direction A1 by the transfer roller 40. It is preferable that the TPH 51 separates from the platen roller 52 before the medium 10 is transferred to the printing nip N1.

Referring to FIG. 10B, the rotating cam 95 is rotated in direction C1, and the cam portion 97 pushes the shaft 84. Because the protrusion 21 of the locking member 20 engages with the first engagement groove 88, rotation of each support bracket 53 is prevented. While the shaft 84 is being pushed in direction D1 along the through hole 85, the TPH 51 is rotated about the hinge hole 82 and separates from the platen roller 52. At this time, the TPH 51 can be rotated without interruption of the end portion 52b because the first and second control portions 54a and 54b are arcuately shaped around the hinge hole 82. In this state, the transfer unit 40 transfers the medium 10 in the first direction A1 so that the medium 10 can reach the printing nip N1. Because the TPH 51 and the platen roller 52 are separated from each other, the medium 10 enters between the TPH 51 and the platen roller 52 without resistance even when the platen roller 52 does not rotate. Referring to FIG. 4, a portion of the medium 10 is discharged from the housing 35 via the aperture 30 and is curved as indicated by reference numeral 10a. After the medium 10 is supplied to the printing nip N1, the transfer unit 40 is stopped.

As shown in FIG. 10C, the rotating cam 95 is rotated in direction C2. Because the protrusion 21 of the locking member 20 engages with the first engagement groove 88, rotation of each support bracket 53 is prevented. The TPH 51 is rotated about the hinge hole 82 in direction D2 by the elastic force of the second elastic member 83 so as to elastically contact the platen roller 52.

In this state, the transfer unit 40 starts transferring the medium 10 in the second direction A2. The platen roller 52 is led in the second direction A2 due to a friction with the medium 10 and moves in the second direction A2 along the slot-shaped inner circumferential portions 91 of the bushings 90 and 90a. When each end 52b of the platen roller 52 contacts the first control portion 54a, movement of the platen roller 52 is stopped. Accordingly, the heating line 59 of the TPH 51 is aligned with the printing nip N1, which is formed by the platen roller 52. The TPH 51 heats the first surface of the medium 10 to print images with M and Y colors on the first surface. Either the Y or M color is represented depending on a temperature or a heating duration of the TPH 51. For example, if the TPH 51 heats the ink layer 12 at a high temperature for a short period of time, the Y color may be emitted. If the TPH 51 heats the ink layer 12 at a low temperature for a long period of time, the M color may be emitted. The discharge roller 60 temporarily discharges the medium 10 on which the first surface has been printed with an image. Referring to FIG. 4, as a portion of the medium 10 remaining outside the aperture becomes shorter, the medium 10 in the state 10a is straightened into the state 10b. During this process, vibrations may occur. However, the vibrations can be greatly reduced by actions of the support member 110 and the first guide 121. Moreover, the vibrations transmitted to the printing nip N1 can be minimized. Thus, this vibration does not affect the quality of printing. When the image printing on the first surface of the medium 10 is complete, the transfer roller 40 stops.

To print an image on the second surface of the medium 10, the transfer of the TPH 51 to the second position is performed. Referring to FIG. 10D, when the rotating cam 95 rotates in direction C2, the cam portion 97 pushes the interfering portion 22 and rotates the locking member 20 in direction E1. Then, the protrusion 21 comes out of the first engagement groove 88 and releases each of the support brackets 53. Thus, the support brackets 53 can be freely rotated. Hence, when the rotating cam 95 continues to rotate in direction C2, and the cam portion 97 pushes the shaft 84, each of the support brackets 53 rotate about a rotating shaft 52a of the platen roller 52 in direction C2 as shown in FIG. 10E. Therefore, instead of the TPH 51 separating from the platen roller 52 in direction D1, while the support brackets 53 are rotating in direction C2, the TPH 51 may slightly separate from the platen roller 52 because the cam portion 97 pushes the shaft 84. When contact between the cam portion 97 and the interfering portion 22 ends, the locking member 20 continuously contacts the outer circumference 87 of each of the support brackets 53 due to an elastic force of the first elastic member 25.

As shown in FIG. 10F, when each of the support brackets 53 rotates 180 degrees, the locking member 20 rotates in direction E2 by an elastic force of the elastic member 25. Thus, the protrusion 21 is inserted into the second engagement groove 89 and each of the support brackets 53 is locked and cannot be rotated further. The TPH 51 reaches the second position facing the second surface of the medium 10.

As shown in FIG. 10G, when the rotating cam 95 continuously rotates in direction C2, rotation of each of the support brackets 53 can be prevented because the protrusion 21 engages with the second engagement groove 89. Instead, the TPH 51 is detached from the platen roller 52 while the shaft 84 is being pushed up along the through hole 85. The transfer unit 40 moves the medium 10 in the first direction A1 to supply the medium 10 to the printing nip N2, and then stops. Referring to FIG. 5, a portion of the medium 10 comes out of the housing 35 via the aperture 30. Then, the medium 10 enters in the state 10d. Referring to FIG. 10H, when the rotating cam 95 rotates in direction C1, rotation of each of the support brackets 53 is prevented because the protrusion 21 engages with the second engagement groove 89. Instead, the TPH 51 comes into contact with the platen roller 52 while the shaft 84 is retreating along the through hole 85.

The transfer unit 40 transfers the medium 10 back in the second direction A2. The platen roller 52 is led in the second direction A2 due to a friction with the medium 10 and moves in the second direction A2 along the slot-shaped inner circumferential portions 91 of the bushings 90 and 90a. When each end 52b of the platen roller 52 contacts the second control portion 54b, movement of the platen roller 52 is stopped. Accordingly, the heating line 59 of the TPH 51 is aligned with the printing nip N2, which is formed by the platen roller 52. The TPH 51 heats the second surface of the medium 10 to print an image with a C color on the second surface. As a portion of the medium 10 remaining outside the aperture 30 becomes shorter, the medium 10 in the state 10d is straightened into the state 10e. During this process, vibrations may occur. However, these vibrations can be greatly reduced by actions of the support member 110 and the second guide 120 and vibrations transmitted to the printing nip N2 can be minimized. Thus, this vibration does not affect the quality of printing. The medium on which first and second surface have been printed with images is discharged from the image forming apparatus by the discharge unit 60.

When double-sided image printing is completed, the rotating cam 95 is rotated in direction C1. The cam portion 97 pushes the interfering portion 22 to rotate the locking member 20 in direction E1. Then, the protrusion 21 disengages from the second engagement groove 89. Thus, each of the support brackets 53 can be freely rotated. When the cam portion 97 pushes the shaft 84 due to continuous rotation of the rotating cam 95 in direction C1, each of the support brackets 53 is continuously rotated in direction C1 until the protrusion 21 is inserted into the first engagement groove 88 by the elastic force of the elastic member 25. Then, the TPH 51 returns back to the first position as shown in FIG. 10A, or the TPH 51 may be located in a position away from the platen roller 52 as shown in FIG. 10B. At this position, the TPH 51 may wait for the next printing.

As described above, in the thermal type image forming apparatus in accordance with exemplary embodiments of the present invention, a support member is installed between a printing nip and an aperture leading to the outside of the image forming apparatus to keep an incidence angle of a medium with respect to the printing nip constant. Moreover, the support member prevents the quality of printing from degrading due to vibration of the medium. Furthermore, a guide unit is installed between the aperture and the support member to more effectively keep an incidence angle of a medium with respect to the printing nip constant and to more effectively prevent the quality of printing from degrading due to vibration of the medium.

While the present invention has been particularly shown and described with reference to exemplary embodiments thereof, it will be understood by those of ordinary skill in the art that various changes in form and details may be made therein without departing from the spirit and scope of the exemplary embodiments of the present invention as defined by the appended claims.

What is claimed is:

1. An image forming apparatus comprising:
a thermal print head;
a platen roller forming a printing nip while facing the thermal print head;
an aperture formed on an upstream side of the printing nip in terms of a direction in which a medium is transferred; and
a support member arranged between the aperture and the printing nip to support the medium on a side opposite to the side where the thermal print head is located.

2. The image forming apparatus of claim 1, wherein:
two thermal print heads face each other while having the platen roller between the thermal print heads; and
the support member supports the medium at a position between each of two printing nips formed by the two thermal print heads in cooperation with the platen roller and the aperture.

3. The image forming apparatus of claim 1, wherein:
the thermal print head rotates about the platen roller to move to a first position facing a first surface of the medium and to a second position facing a second surface of the medium that is opposite to the first surface; and
the support member supports the medium at a position between each of two printing nips formed by the thermal print head at the first and second positions and the aperture.

4. The thermal type image forming apparatus of claim 1, further comprising a guide unit positioned between the aperture and the support member, the guide unit configured to support the medium on a side opposite to the side where the support member is installed.

5. The image forming apparatus of claim 4, wherein:
two thermal print heads face each other while having the platen roller between the thermal print heads; and
the support member supports the medium at a position between each of two printing nips formed by the two thermal print heads in cooperation with the platen roller and the aperture.

6. The image forming apparatus of claim 5, wherein the guide unit comprises a first guide unit and a second guide unit facing each other while having the support member between the first and second guide units.

7. The image forming apparatus of claim 5, wherein:
the thermal print head rotates about the platen roller to move to the first position facing the first surface of the medium and to the second position facing the second surface of the medium that is opposite to the first surface; and
the support member supports the medium at a position between each of two printing nips formed by the thermal print head at the first and second positions and the aperture.

8. The image forming apparatus of claim 7, wherein the guide unit comprises a first guide unit and a second guide unit facing each other while having the support member between the first and second guide units.

9. An image forming apparatus comprising:
a thermal print head;
a platen roller forming a printing nip while facing the thermal print head;
a transfer unit transferring a medium in a first direction to supply the medium to the printing nip and in a second direction opposite to the first direction;
an aperture formed on the first direction side of the printing nip through which the medium being transferred in the first direction is discharged; and
a support member arranged between the aperture and the printing nip to support the medium on a side opposite to the side where the thermal print head is located.

10. The image forming apparatus of claim 9, wherein further comprising a guide unit positioned between the aperture and the support member configured to support the medium on a side opposite to the side where the support member is installed.

11. The image forming apparatus of claim 10, wherein:
the thermal print head rotates about the platen roller to move to the first position facing the first surface of the medium and to the second position facing the second surface of the medium that is opposite to the first surface; and
the support member supports the medium at a position between each of two printing nips formed by the thermal print head at the first and second positions and the aperture.

12. The image forming apparatus of claim 11, wherein the guide unit comprises a first guide unit and a second guide unit facing each other while having the support member between the first and second guide units.

13. The image forming apparatus of claim 10, wherein:
two thermal print heads face each other while having the platen roller between the thermal print heads; and
the support member supports the medium at a position between each of two printing nips formed by the two thermal print heads in cooperation with the platen roller and the aperture.

14. The image forming apparatus of claim 13, wherein the guide unit comprises a first guide unit and a second guide unit facing each other while having the support member between the first and second guide units.
